(19) United States
(12) Patent Application Publication
(10) Pub. No.: US 2007/0244631 A1
(43) Pub. Date: Oct. 18, 2007

(54) Navigation System and Method for Controlling the Same

(75) Inventors: Mun Ho Jung, Gyeonggi-do (KR); Dong Hoon Yi, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/570,562

(22) PCT Filed: Jun. 13, 2005
(86) PCT No.: PCT/KR05/01791

§ 371 Date: Dec. 13, 2006

(30) Foreign Application Priority Data
Jun. 15, 2004 (KR) 10-2004-0044169

(51) Int. Cl. G01C 21/10; G01C 21/34

(52) U.S. Cl. 701/201; 701/213

(57) ABSTRACT

A navigation system and a method for controlling the same wherein navigation functions are integrally mounted in a mobile communication terminal to enable to guide the travel of a mobile object in real time. A GPS receiving module is integrally mounted in the mobile communication terminal to receive navigation messages transmitted by the GPS satellites and to detect the position of the mobile object, terrestrial magnetic field is detected by a terrestrial magnetic field sensor module to detect an azimuth of the mobile object, an acceleration speed is detected by an acceleration speed sensor, and the travel speed of the mobile object is calculated by a speed detecting module using the acceleration speed thus detected, a current position of the mobile object is determined by an output signal from the GPS receiving module, the terrestrial magnetic field sensor module, and the speed detecting module, and the current position of the mobile object thus determined is matched to a map data stored in a map storage for display in a display unit.

### TECHNICAL FIELD

The present invention relates to a navigation system and a method for controlling the same adapted to be equipped at a mobile communication terminal to guide a travel of a predetermined mobile object.

### BACKGROUND ART

Concomitant with the development of position acquisition technology using Global Positioning System (GPS) and the field of telematics which is multimedia system used in a mobile object such as a vehicle, necessity of low and medium priced navigation systems has been continuously proposed.

Generally, the navigation system includes a position acquisition module for acquiring a current position information of a predetermined mobile object, a route calculation module for calculating a travel route of the mobile object, and a route guide module for guiding a travel route of the mobile object. The navigation system further includes a communication module for receiving supplementary services such as traffic information and the like.

The communication module basically capable of performing an interactive communication needs a communication module such as Code Division Multiple Access (CDMA) or Global System for Mobile communication (GSM). However, a communication module for CDMA or GSM is very expensive to pose as an obstacle to the development of low and medium priced navigation systems.

In order to solve the afore-mentioned problems, a low priced service has emerged where mobile communication terminals handcarried by many users are mounted with built-in GPS receiving modules enabling to be provided with navigation services. However, the mobile communication terminals equipped with the navigation services are used only as a modem for communication and as a monitor for displaying information on a screen.

In other words, there is a problem in the navigation services using the conventional mobile communication terminals in that a user accesses to a navigation service provider via his or her mobile communication terminal to download map and traffic information, and the downloaded map and traffic information are displayed on a screen such that it takes some time to get downloaded with the map and traffic information, making it almost impossible to get guided on the travel of a mobile object in real time.

There is another problem in that, although information such as travel speed and travel direction of a mobile object is needed for precisely guiding a current position and a travel state of the mobile object, the mobile communication terminal cannot accurately obtain information such as a travel speed and a travel direction of a mobile object on a real time base.

There is still another problem in that, although navigation messages received by a GPS receiving module mounted in a mobile communication terminal can be used to extract information such as a travel speed and a travel direction, a current position and a travel of a mobile object cannot be accurately guided because a period in which the GPS receiving module receives the navigation messages is approximately over 1 second.

As a result, a need has been proposed for a mobile communication terminal capable of guiding a travel of a predetermined mobile object by integrally mounting a mobile communication terminal with all the functions necessary for implementing navigation services concomitant with the technical development of mobile communication.

### DISCLOSURE OF INVENTION

### Technical Problem

Accordingly, the present invention is conceived to solve the aforementioned problems in the prior art. An object of the present invention is to provide a navigation system and a method controlling the same adapted to mount a GPS receiving module and a digital map data in a mobile communication terminal, enabling to guide a travel of a mobile object on a real time base.

Another object of the present invention is to provide a navigation system and a method controlling the same adapted to use a terrestrial magnetism sensor module and an acceleration speed sensor, enabling to accurately detect travel direction and speed of a mobile object on a real time base.

Still another object is to provide a navigation system and a method controlling the same adapted to detect a current temperature and to correct a travel speed of a mobile object in response to the detected temperature, enabling to detect an accurate travel speed of the mobile object.

### TECHNICAL SOLUTION

In accordance with one aspect of the present invention, there is provided a navigation system comprising: a GPS receiving module for receiving navigation messages transmitted from GPS satellites via an antenna; a terrestrial magnetic field sensor module for detecting a terrestrial magnetic field; an acceleration speed sensor for detecting an acceleration speed of a mobile object; a speed detecting module for detecting a travel speed of the mobile object using the acceleration speed detected by the acceleration speed sensor; a map storage for storing a map data; and a central processing unit for determining a current position of the mobile object via output signals outputted from the GPS receiving module, the terrestrial magnetism sensor module and the speed detecting module and matching the current position of the mobile object thus determined to a map data stored in the map storage and displaying the matched map data on a display unit.

In accordance with another aspect of the present invention, there is provided a navigation system comprising: a telephone communication unit for implementing a telephone communication; a modulating/demodulating unit mounted between an antenna and the telephone communication unit for demodulating a voice signal received via the antenna to output the modulated voice signal to the telephone communication unit, and modulating the voice signal inputted from the telephone communication unit to transmit the modulated voice signal via the antenna; a GPS receiving module for receiving navigation messages transmitted from GPS satellites via an antenna; a terrestrial magnetic field sensor module for detecting a terrestrial magnetic field; an acceleration speed sensor for detecting an acceleration speed of a mobile object; a speed detecting module for detecting a travel speed of the mobile object using the acceleration speed detected by the acceleration speed sensor; a map storage for storing a map data; and a central processing unit for determining a current position of the mobile object via output signals outputted from the GPS receiving module, the terrestrial magnetism sensor module and the speed detecting module and matching the current position of the mobile object thus determined to a map data stored in the map storage and displaying the matched map data on a display unit.

The GPS receiving module receives navigation messages transmitted by at least four GPS satellites among the navigation messages transmitted by a plurality of GPS satellites to extract a current position of a mobile object, and the terrestrial magnetism sensor module detects a magnetic field of the Earth and calculates an azimuth of the mobile object in response to the detected magnetic field, and the map data stored in the map storage includes at least one of the following data which are background map data containing polygon and polyline attribute information, road map data containing index of link, attribute of link, node information, contour point information, Point of Interest (POI) containing POI index, destination name, address, position and classification code, and road search map data containing contour information of link, turn, left turn, right turn, straight ahead information at a cross road and connecting information of link.

The navigation system further comprises a temperature sensor for detecting a current temperature, and the speed detecting module temperature-compensates the acceleration speed detected by the acceleration speed sensor in response to the current temperature detected by the temperature sensor to detect a travel speed of the mobile object.

The speed detecting module comprises: a temperature compensating unit for temperature-compensating the acceleration speed detected by the acceleration speed sensor in response to the current temperature detected by the temperature sensor; an integrator for integrating an acceleration speed detection signal temperature-compensated by the temperature compensating unit; and a speed accumulator for accumulating integrated signals of the integrator to detect a travel speed of a mobile object, and the temperature compensating unit comprises: a temperature difference calculating unit for calculating a temperature difference between the current temperature detected by the temperature sensor and a predetermined reference temperature; a temperature inclination discriminating unit for discriminating a temperature inclination of the acceleration sensor relative to the current temperature detected by the temperature sensor; and a correcting unit for correcting the acceleration speed detected by the acceleration speed sensor in response to the temperature difference calculated by the temperature difference calculating unit and the temperature inclination discriminated by the temperature inclination discriminating unit.

In accordance with still another aspect of the present invention, there is provided a controlling method of a navigation system, the method comprising the steps of: reading out a map data of a predetermined region from a map storage based on a current position of a mobile object detected by a GPS receiving module receiving navigation messages; discriminating whether there is a trustworthiness of the current position of the mobile object detected by the GPS receiving module via the navigation messages; determining as a current position of the mobile object the position detected by the GPS receiving module via the navigation messages if there is trustworthiness as a result of the discrimination; determining a current position of the mobile object by using the terrestrial magnetic field detected by the terrestrial magnetic field sensor module and the acceleration speed of the mobile object detected by the acceleration speed sensor if there is no trustworthiness as a result of the discrimination; and matching the current position of the mobile object thus determined to the map data and displaying the matched current position of the mobile object on a display unit.

In accordance with still further aspect of the present invention, there is provided a controlling method of a navigation system, the method comprising the steps of: reading out a map data from a map storage to search a travel route of a mobile object from a starting point to a destination of the mobile object; discriminating whether there is a trustworthiness in a current position of the mobile object detected by a GPS receiving module via navigation messages if the mobile object travels following the search of the travel route; determining as a current position of the mobile object the position detected by the GPS receiving module receiving the navigation messages if there is a trustworthiness as a result of the discrimination; determining a current position of the mobile object by using the terrestrial magnetic field detected by the terrestrial magnetic field sensor module and the acceleration speed of the mobile object detected by the acceleration speed sensor if there is no trustworthiness as a result of the discrimination; and matching the current position of the mobile object thus determined to the map data, displaying the matched current position of the mobile object on a display unit and guiding the searched travel route.

The discrimination of trustworthiness is conducted by a value of Dilution of Precision (DOP) outputted by the GPS receiving module.

The step of determining the current position of the mobile object by way of the terrestrial magnetic field detected by the terrestrial magnetic field sensor module and the acceleration speed detected by the acceleration speed sensor further comprises the steps of: discriminating the azimuth of the mobile object by the terrestrial magnetic field detected by the terrestrial magnetic field sensor module; integrating the acceleration speed detected by the acceleration speed sensor and accumulating integrated signals and discriminating the travel speed of the mobile object; and discriminating the current position of the mobile object by accumulating the azimuth and the travel speed discriminated from a final position where the position detected by the GPS receiving module via the navigation messages was regarded as trustworthy to thereby discriminate the current position of the mobile object.

The travel speed discrimination is conducted by temperature-compensating and integrating the acceleration speed detected by the acceleration speed sensor in response to the current temperature detected by the temperature sensor, and accumulating the integrated signals.

The temperature compensation comprises the steps of: calculating a temperature difference between the current temperature detected by the temperature sensor and the predetermined temperature; discriminating a temperature inclination of the acceleration speed sensor relative to the current temperature detected by the temperature sensor; and temperature-compensating the acceleration speed in response to the temperature difference and the temperature inclination.

The temperature-compensation of the acceleration speed in response to the temperature difference and the temperature inclination is conducted by a predetermined Expression.

The controlling method of navigation system is further conducted by turning, enlarging and scale-downing a map displayed on a display unit in response to a command inputted from a command input unit.

### ADVANTAGEOUS EFFECTS

As described in the foregoing, the present invention is adapted to mount a built-in navigation function in a mobile communication terminal for guiding a mobile object, whereby a current position and a travel of the mobile object can be guided in real-time and the navigation function can be used by a user at a moderate price.

### BRIEF DESCRIPTION OF THE DRAWINGS

FIG. 1 is a block diagram illustrating a construction of a navigation system according to the present invention.

FIG. 2 is a block diagram illustrating a construction of a speed detecting module in a navigation system according to the present invention.

FIG. 3 is a signal flow chart illustrating an embodiment of a controlling method according to the present invention.

FIG. 4 is a signal flow chart illustrating another embodiment of a controlling method according to the present invention.

### BEST MODE FOR CARRYING OUT THE INVENTION

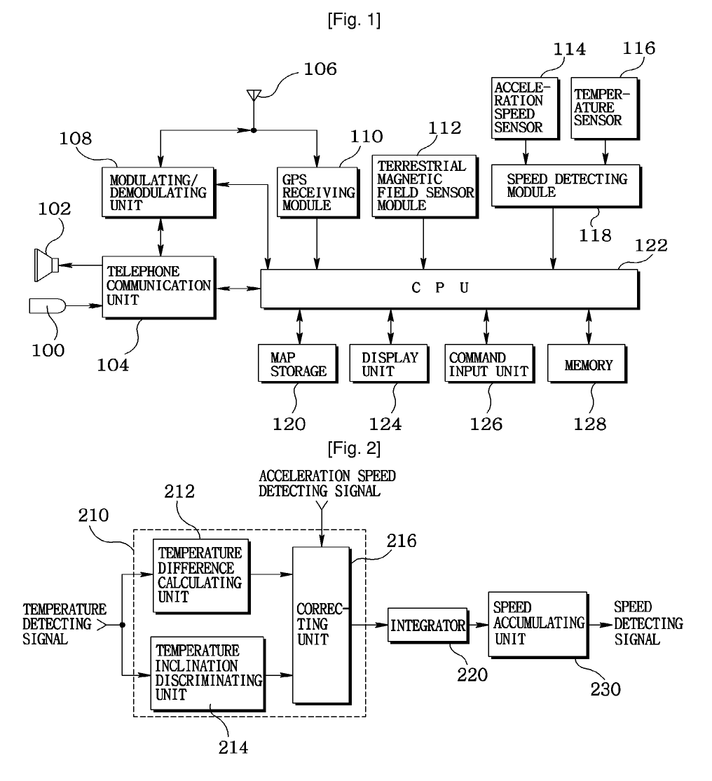

FIG. 1 is a block diagram illustrating a construction of a navigation system according to the present invention, where reference numeral 100 denotes a microphone, 102 denotes a speaker, and 104 denotes a telephone communication unit. The telephone communication unit receives a voice signal of a user via the microphone (100) and processes the voice signal. The telephone communication unit (100) also outputs a voice signal of a caller inputted from the modulating/demodulating unit (108. described later) to the speaker (102) to allow a user to effect a telephone communication.

Reference numeral 106 denotes an antenna, and 108 denotes a modulating/demodulating unit. The modulating/demodulating unit 108 demodulates the voice signal of a caller received via the antenna (106) and outputs the demodulated voice signal to the telephone communication unit (104), and modulates a voice signal of a user inputted from the telephone communication unit (104) and transmits the modulated voice signal via the antenna (106).

Reference numeral 110 denotes a GPS receiving module for receiving navigation messages transmitted from a plurality of GPS satellites, and reference numeral 112 denotes a terrestrial magnetic field sensor module for detecting the terrestrial magnetic field and an azimuth of a mobile communication terminal, i.e., the azimuth on which the mobile object travels, in response to the detected terrestrial magnetic field.

Reference numeral 114 denotes an acceleration speed sensor for detecting an acceleration speed of the mobile object, and 116 is a temperature sensor for detecting a current temperature. Reference numeral 118 is a speed detecting module for detecting a travel speed of a mobile object by correcting the acceleration speed detected by the acceleration speed sensor (114) in response to the current temperature detected by the temperature sensor (116).

Reference numeral 120 is map storage where a digital map data is stored, and reference numeral 122 is a Central Processing Unit (CPU). The CPU controls the telephone communication unit (104) and the modulating/demodulating unit (108) enabling to conduct a telephone communication. The CPU also uses the navigation messages received by the GPS receiving module (110), the travel speed of the mobile object detected by the speed detecting module (118) and the azimuth detected by the terrestrial magnetic field sensor module (112) to detect a current position of the mobile object, and controls the display of the current position of the mobile object by matching the detected current position to the digital map stored in the map storage (120).

Reference numeral 124 denotes a display unit. The display unit (124) displays a telephone communication state and the map where the position and azimuth of the mobile object are matched under the control of the CPU (122). Reference numeral 126 denotes a command input unit for inputting a command according to the manipulation of a user to the CPU (122). Reference numeral 128 is a memory for temporarily storing an operation data of the CPU (122).

Referring FIG. 2, the speed detecting module (118) compensates the acceleration speed detected by the acceleration speed sensor (114) in response to the signal detected by the temperature sensor (116). The temperature compensating unit (210) includes a temperature difference calculating unit (212), a temperature inclination discriminating unit (214) and a correcting unit (216).

The temperature difference calculating unit (212) compares the current temperature detected by the temperature sensor (116) with a predetermined temperature to calculate a temperature difference. The temperature inclination discriminating unit (214) discriminates whether a temperature inclination characteristic of the acceleration speed sensor (114) is positive or negative relative to the current temperature detected by the temperature sensor (116). The correcting unit (216) corrects a value of the acceleration speed detection signal detected by the acceleration speed sensor (114) in response to the temperature difference calculated by the temperature difference calculating unit (212) and the temperature inclination discriminated by the temperature inclination discriminating unit (214). The acceleration detection signal corrected by the correcting unit (216) is integrated by an integrator (220), and an integrated signal of the integrator (220) is accumulated by the speed accumulating unit (230), causing a speed detection signal of the mobile object to be outputted.

In the navigation system thus constructed, when a user manipulates the command input unit (126) to instruct a telephone communication, the CPU (122) controls the telephone communication unit (104) and the modulating/demodulating unit (108) to allow the voice signal of the user to be inputted via the microphone (100) and processed by the telephone communication unit (104). The processed voice signal is modulated by the modulating/demodulating unit (108) to be transmitted via the antenna (106). The voice signal of the caller received via the antenna (106) is demodulated by the modulating/demodulating unit (108), and processed by the telephone communication unit (104) to be outputted to the speaker (102), enabling the user to make a telephone communication.

Furthermore, when the user manipulates the command input unit (126) to instruct the operation of the navigation service, the CPU (122) receives the navigation messages received by the GPS receiving module (110) to detect the current position of the mobile object. In other words, the GPS receiving module (110) receives navigation messages transmitted by at least four GPS satellites among the navigation messages transmitted by a plurality of GPS satellites to detect a current position of a mobile object. The GPS receiving module (110) also calculates a value of DOP which is a geometric error relative to the relationship of arrangement of the GPS satellites transmitting the navigation messages used for detecting the current position of the mobile object based on a position of the GPS receiving module (110). In other words, the DOP is a parameter that indicates the probabilities of measured coordinates based on geometric configurations of used satellites with regard to a mobile object. For example, if the GSP satellites are evenly arranged based on the position of a GPS receiver, the value of the DOP is low, while the value of the DOP is high if the GPS satellites are not uniformly arranged. If the value of the DOP is less than 2, this is an excellent case. If the value of the DOP ranges from 2 to 3, this is a good case. If the value of the DOP ranges from 4 to 5, this is a regular case. If the value of the DOP is equal to or greater than 6, this cannot be utilized due to many errors in the current position of the mobile object detected by the received navigation messages.

The CPU (122) receives a detection signal of the terrestrial magnetic field sensor module (112) to discriminate an azimuth of the mobile object. The acceleration speed sensor (114) detects a moving acceleration speed of the mobile object in response to the movement of the mobile object to output an acceleration speed detection signal to the speed detecting module (118). The temperature sensor (116) detects a current temperature to output a temperature detection signal to the speed detecting module (118).

The speed detecting module (118) calculates a temperature difference between the current temperature detected by the temperature sensor (116) of the temperature calculating unit (212) at the temperature compensating unit (210) and the preset reference temperature. For example, the temperature difference calculating unit (212) is given 25 degrees celcius as a reference temperature, and the current temperature detected by the temperature sensor (116) is subtracted by the preset reference temperature to calculate the temperature difference, and the temperature difference is outputted to the correcting unit (216).

Furthermore, the temperature inclination discriminating unit (214) of the speed detecting module (118) detects a temperature inclination of the acceleration speed sensor (114) relative to the temperature detected by the temperature sensor (116). In other words, the operational characteristic of the acceleration speed sensor (114) is such that the temperature inclination has a positive value or a negative value in response to the temperature. The temperature inclination discriminating unit (214) discriminates whether the temperature inclination of the acceleration speed sensor (114) relative to the current temperature detected by the temperature sensor (116) has a positive or a negative value. Preferably, as a discriminating basis of the temperature inclination, the temperature inclination of the acceleration speed sensor (114) relative to each temperature is pre-stored in a look-up table, and the temperature inclination of the acceleration speed sensor (114) relative to the current temperature detected by the temperature sensor (116) is sought after from the look-up table and outputted to the correcting unit (216).

The correcting unit (216) temperature-compensates the acceleration detection signal detected by the acceleration speed sensor (114) in response to the temperature difference calculated by the temperature difference calculating unit (212) and the temperature inclination discriminated by the temperature inclination discriminating unit (214). The temperature compensation, for example, can be effected according to the following Expression 1 if the temperature inclination is positive, and if the temperature inclination is negative, the temperature compensation is implemented by the following Expression 2.
A=A1+(temperature difference×temperature coefficient) <Expression 1>
A=A1−(temperature difference×temperature coefficient), where A is temperature-compensated acceleration speed, and A1 is an acceleration speed detected by the acceleration speed sensor (114). <Expression 2>

The acceleration speed detection signal temperature-compensated by the correcting unit (216) is integrated by the integrator (220) and accumulated by a speed accumulating unit, whereby a travel speed of the mobile object is detected and the detected travel speed of the mobile object is inputted to the CPU (122). The CPU (122) reads out from the map storage (120) a map data of a predetermined region based on the current position of the mobile object detected by the GPS receiving module (110). In other words, the map storage (120) is pre-stored with digital map data including background map data containing polygon and polyline attribute information, road map data containing index of link, attribute of link, node information, contour point information, Point of Interest (POI) containing POI index, destination name, address, position and classification code, and road search map data containing contour information of link, turn, left turn, right turn, straight ahead information at a cross road and connecting information of link. The CPU (122) reads out the background map data of a predetermined region, road map data, POI and road search map data based on the current position of mobile object thus discriminated.

Once the map data is read out, the CPU (122) determines the current position of the mobile object using the current position of the mobile object detected by the GPS receiving module (110), the outputted signal of the terrestrial magnetic field sensor module (112) and the speed detecting module (118). In other words, the CPU (122) discriminates whether the current position of the mobile object detected by the GPS receiving module is trustworthy in response to the value of DOP in case the GPS receiving module (110) detects the current position of the mobile object and outputs the current position. As a result of the discrimination, if there is trustworthiness, the position detected by the GPS receiving module (110) is determined as the current position of the mobile object. If there is no trustworthiness due to no output of current position of the mobile object from the GPS receiving module (110) or due to high value of the DOP, a position of the mobile object is determined as the current position of the mobile object, the position detected by using the output signal of the terrestrial magnetic field sensor module (112) and the speed detecting module (118) obtained from the final position of the mobile object detected by the navigation messages. The CPU (122) matches the current position of the mobile object thus determined to the map data thus read out, and outputs it to the display unit (124) for display thereon.

### MODE FOR THE INVENTION

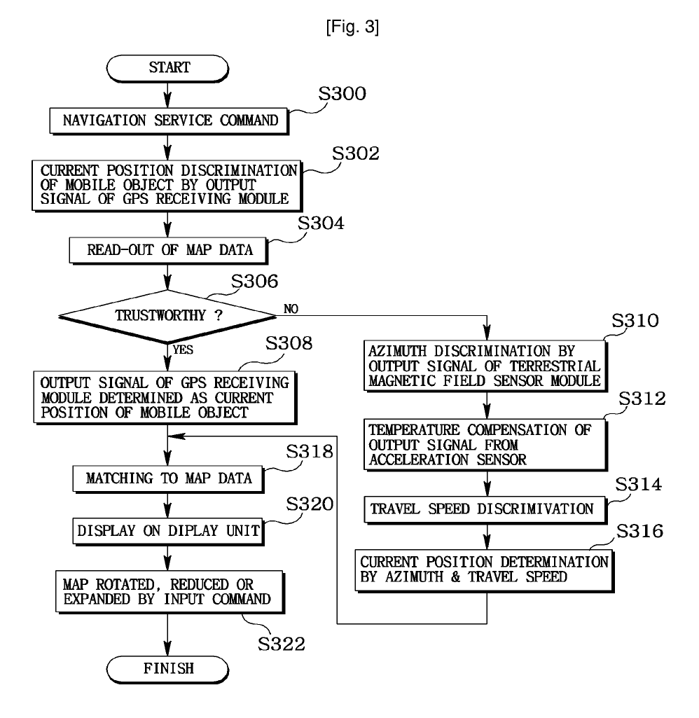

FIG. 3 is a signal flow chart illustrating an embodiment of a controlling method according to the present invention.

Referring to FIG. 3, when a user manipulates the command input unit (126) to instruct an operation of navigation service at S300, the CPU (122) discriminates the current position of the mobile object by way of the output signal from the GPS receiving module (110) (S302).

The CPU (122) reads out the map data of a predetermined region from the map storage (120) based on the current position of the mobile object thus discriminated (S304), and discriminates whether the current position of the mobile object discriminated by the navigation messages of the GPS receiving module (110) according to the value of DOP outputted by the GPS receiving module (110) is trustworthy (S306).

As a result of the discrimination at S306, if there is trustworthiness, the CPU (122) determines the output signal of the GPS receiving module (110) as the current position of the mobile object (S308). In other words, the position discriminated by the navigation messages received by the GPS receiving module (110) is determined as the current position of the mobile object.

Successively, as a result of the discrimination at S306, if there is no trustworthiness, or if the GPS receiving module (110) has not outputted the current position of the mobile object, the CPU (122) discriminates the azimuth of the mobile object by way of the output signal of the terrestrial magnetic field sensor module (112) (S310). The temperature compensating unit (210) temperature-compensates the acceleration detection signal of the acceleration speed sensor (114) (S312). The travel speed of the mobile object is discriminated at S314 by the acceleration speed detection signal temperature-compensated. In other words, the acceleration speed detection signal temperature-compensating unit (210) is integrated by the integrator (220) and accumulated by the speed accumulating unit (230). The accumulated value is used by the CPU (122) to discriminate the travel speed of the mobile object.

The CPU (122) uses the azimuth and travel speed of the mobile object thus discriminated to determine the current position of the mobile object (S316). In other words, if the navigation messages received by the GPS receiving module (110) is trustworthy, a current position of the mobile object is determined by the position detected by using the output signal of the terrestrial magnetic field sensor module (112) and the speed detecting module (118) from a final position of the mobile object detected by the navigation messages.

Once the current position of the mobile object is determined by the aforementioned method, the CPU (122) matches the current position of the mobile object thud determined to the map data (S318), and outputs the matched map data and the current position of the mobile object to the display unit (124) for display thereon (S320).

The user manipulates the command input unit (126) to rotate, expand or reduce the map displayed on the display unit (124) in response to the inputted instruction (S322). In other words, when the mobile communication terminal is manipulated at a predetermined mobile object to implement the navigation operation, conventionally, the mobile communication terminal is installed at an installation for use. However, in this case, chances are that the travel direction of the mobile object and the map direction displayed on the display unit (124) are not matched.

In order to address the problem, in the present invention, when a user manipulates the command input unit (126) to instruct a rotation, the map displayed on the display unit (124) is instead rotated to enable to match the travel direction of the mobile object and the map direction displayed on the display unit (124).

Furthermore, the size of the display screen of the display unit (124) of the mobile communication terminal is limited, such that the size of the map can be adjusted in response to the manipulation of the user to the satisfaction of the user.

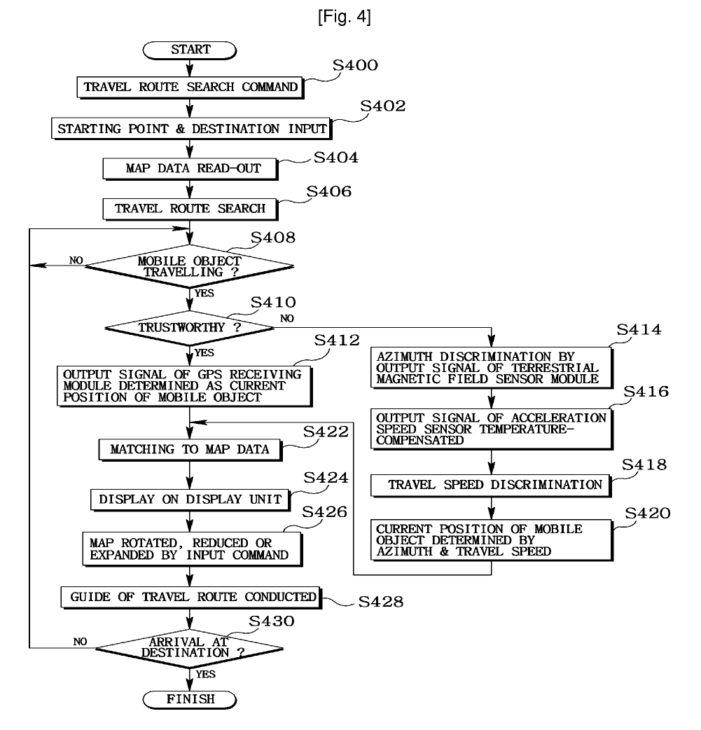

FIG. 4 is a signal flow chart illustrating another embodiment of a controlling method according to the present invention, where the travel route of the mobile object is searched and the travel of the mobile object is guided in response to the searched travel route of the mobile object.

Referring to FIG. 4, if a user manipulates the command input unit (126) to instruct the search of the travel route of the mobile object (S400), the CPU (122) inputs a starting point and a destination of the mobile object via the command input unit (126) (S402). The current position of the mobile object detected by the output signal of the GPS receiving module (110), the terrestrial magnetic field sensor module (112) and the speed detecting module (118) may be determined as the starting point.

Once the starting point and destination of the mobile object are determined, the CPU (122) reads out the map data stored in the map storage (120) (S404), and the map data thus read out is utilized to search a travel route from the starting point to the destination of the mobile object (S406).

When the mobile object moves (S408), the CPU (122) discriminates whether the current position of the mobile object discriminated by the navigation messages by the GPS receiving module (110) in response to the value of the DOP outputted by the GPS receiving module (110) is trustworthy S410, and as a result of the discrimination at S410, if there is trustworthiness, the CPU (122) determines the position detected by the GPS receiving module (110) as the current position of the mobile object.

Furthermore, if the trustworthiness is not found or if the GPS receiving module (1100 has not outputted the current position of the mobile object as a result of the discrimination at S410, the CPU (122) discriminates at S414 an azimuth of the mobile object by way of the output signal of the terrestrial magnetic field sensor module (123), and the temperature compensating unit (210) temperature-compensates the acceleration speed detection signal of the acceleration speed sensor (114) (S416), and the travel speed of the mobile object is discriminated by the temperature-compensated acceleration speed detection signal (S418).

Successively, the CPU (122) uses the azimuth and travel speed of the mobile object thus discriminated to determine the current position of the mobile object (S420).

Once the current position of the mobile object is determined, the CPU (122) matches the current position of the mobile object thus determined to the map data (S422), and the map data and the current position of the mobile object are outputted to the display unit (124) for display thereon (S424). The map displayed on the display unit (124) is rotated, expanded or reduced in response to the instruction inputted by the manipulation of the command input unit (126) by the user (S426).

If a predetermined guide object such as crossroad or the like is located in front of the traveling mobile object, the travel route is guided at the relevant guide object (S428), and discrimination is made at S430 as to whether the mobile object has arrived at the destination.

If the mobile object has not arrived at the destination as the result of the discrimination at S430, the CPU (122) returns to S408 to repeat the operations where the current position of the mobile object is determined, the determined current position of the mobile object is displayed on the display unit (124) and the travel route of the mobile object is guided. As a result of the discrimination at S430, if the mobile object has arrived at the destination, the CPU (122) finishes the operation.

While the present invention has been described with respect to certain preferred embodiments, it will be apparent to those skilled in the art that various changes and modifications may be made without departing from the scope and spirit of the invention as defined in the following claims.

For example, although in the present invention, navigation services are conducted by mounting a built-in navigation system in a mobile communication terminal, the navigation services may be implemented without mounting a built-in navigation system in the mobile communication terminal for the embodiments of the present invention. Furthermore, an example has been given in the present embodiment where the modulating/demodulating unit (108) and the GPS receiving module (110) commonly use one antenna (106), but it should be apparent that separate antennas may be used for the modulating/demodulating unit (108) and the GPS receiving module (110).

### INDUSTRIAL APPLICABILITY

Accordingly, the present invention is equipped with a mobile communication terminal mounted with built-in navigation functions, enabling to guide the traveling of a mobile object. The present invention also enables to guide a travel route of a user when the user moves on foot to a destination without recourse to a mobile object.

1. A navigation system comprising:
a GPS receiving module for receiving navigation messages transmitted from GPS satellites via an antenna;
a terrestrial magnetic field sensor module for detecting a terrestrial magnetic field;
an acceleration speed sensor for detecting an acceleration speed of a mobile object;
a speed detecting module for detecting a travel speed of the mobile object using the acceleration speed detected by the acceleration speed sensor;
a map storage for storing a map data; and a central processing unit for determining a current position of the mobile object via output signals outputted from the GPS receiving module, the terrestrial magnetism sensor module and the speed detecting module and matching the current position of the mobile object thus determined to a map data stored in the map storage and displaying the matched map data on a display unit.

2. The system as defined in claim 1, wherein the GPS receiving module receives navigation messages transmitted by at least four GPS satellites among the navigation messages transmitted by a plurality of GPS satellites to detect the current position of the mobile object.

3. The system as defined in claim 1, wherein and the terrestrial magnetism sensor module detects a magnetic field of the Earth and calculates an azimuth of the mobile object in response to the detected magnetic field.

4. The system as defined in claim 1, wherein the map data stored in the map storage comprises at least one of the following data which are background map data containing polygon and polyline attribute information, road map data containing index of link, attribute of link, node information, contour point information, Point of Interest (POI) containing POI index, destination name, address, position and classification code, and road search map data containing contour information of link, turn, left turn, right turn, straight ahead information at a cross road and connecting information of link.

5. The system as defined in claim 1, further comprising a temperature sensor for detecting a current temperature, and the speed detecting module temperature-compensates the acceleration speed detected by the acceleration speed sensor in response to the current temperature detected by the temperature sensor to detect a travel speed of the mobile object.

6. The system as defined in claim 5, wherein the speed detecting module comprises:
a temperature compensating unit for temperature-compensating the acceleration speed detected by the acceleration speed sensor in response to the current temperature detected by the temperature sensor; an integrator for integrating the acceleration speed detection signal temperature-compensated by the temperature compensating unit; and a speed accumulating unit for accumulating the integrated signals of the integrator to detect the travel speed of the mobile object.

7. The system as defined in claim 6, wherein the temperature-compensating unit comprises: a temperature difference calculating unit for calculating a temperature difference between the current temperature detected by the temperature sensor and a predetermined reference temperature; a temperature inclination discriminating unit for discriminating a temperature inclination of the acceleration sensor relative to the current temperature detected by the temperature sensor; and a correcting unit for correcting the acceleration speed detected by the acceleration speed sensor in response to the temperature difference calculated by the temperature difference calculating unit and the temperature inclination discriminated by the temperature inclination discriminating unit.

8. A navigation system comprising: a telephone communication unit for implementing a telephone communication; a modulating/demodulating unit mounted between an antenna and the telephone communication unit for demodulating a voice signal received via the antenna to output the modulated voice signal to the telephone communication unit, and modulating the voice signal inputted from the telephone communication unit to transmit the modulated voice signal via the antenna; a GPS receiving module for receiving navigation messages transmitted from GPS satellites via an antenna; a terrestrial magnetic field sensor module for detecting a terrestrial magnetic field; an acceleration speed sensor for detecting an acceleration speed of a mobile object; a speed detecting module for detecting a travel speed of the mobile object using the acceleration speed detected by the acceleration speed sensor; a map storage for storing a map data; and a central processing unit for determining a current position of the mobile object via output signals outputted from the GPS receiving module, the terrestrial magnetism sensor module and the speed detecting module and matching the current position of the mobile object thus determined to a map data stored in the map storage and displaying the matched map data on a display unit.

9. The system as defined in claim 8, wherein the antenna connected to the modulating/demodulating unit and the antenna by which the GSP receiving module receives the navigation messages are the same one antenna.

10. The system as defined in claim 8, wherein the antenna connected to the modulating/demodulating unit and the antenna by which the GPS receiving module receives the navigation messages are separate antennas.

11. The system as defined in claim 8, wherein the GPS receiving module receives navigation messages transmitted by at least four GPS satellites among the navigation messages transmitted by a plurality of GPS satellites to detect the current position of the mobile object.

12. The system as defined in claim 8, wherein and the terrestrial magnetism sensor module detects a terrestrial magnetic field of the Earth and calculates an azimuth of the mobile object in response to the detected terrestrial magnetic field.

13. The system as defined in claim 8, wherein the map data stored in the map storage includes at least one of the following data which are background map data containing polygon and polyline attribute information, road map data containing index of link, attribute of link, node information, contour point information, Point of Interest (POI) containing POI index, destination name, address, position and classification code, and road search map data containing contour information of link, turn, left turn, right turn, straight ahead information at a cross road and connecting information of link.

14. The system as defined in claim 8 further comprising a temperature sensor for detecting the current temperature, and the speed detecting module temperature-compensates the acceleration speed detected by the acceleration speed sensor in response to the current temperature detected by the temperature sensor.

15. The system as defined in claim 14, wherein the speed detecting module comprises: a temperature compensating unit for temperature-compensating the acceleration speed detected by the acceleration speed sensor in response to the current temperature detected by the temperature sensor; an integrator for integrating an acceleration speed detection signal temperature-compensated by the temperature compensating unit; and a speed accumulator for accumulating integrated signals of the integrator to detect a travel speed of a mobile object.

16. The system as defined in claim 15, wherein the temperature compensating unit comprises: a temperature difference calculating unit for calculating a temperature difference between the current temperature detected by the temperature sensor and a predetermined reference temperature; a temperature inclination discriminating unit for discriminating a temperature inclination of the acceleration sensor relative to the current temperature detected by the temperature sensor; and a correcting unit for correcting the acceleration speed detected by the acceleration speed sensor in response to the temperature difference calculated by the temperature difference calculating unit and the temperature inclination discriminated by the temperature inclination discriminating unit.

17. A controlling method of a navigation system, the method comprising the steps of: reading out a map data of a predetermined region from a map storage based on a current position of a mobile object detected by a GPS receiving module receiving navigation messages; discriminating whether there is a trustworthiness of the current position of the mobile object detected by the GPS receiving module via the navigation messages; determining as a current position of the mobile object the position detected by the GPS receiving module via the navigation messages if there is trustworthiness as a result of the discrimination; determining a current position of the mobile object by using the terrestrial magnetic field detected by the terrestrial magnetic field sensor module and the acceleration speed of the mobile object detected by the acceleration speed sensor if there is no trustworthiness as a result of the discrimination; and matching the current position of the mobile object thus determined to the map data and displaying the matched current position of the mobile object on a display unit.

18. The method as defined in claim 17, wherein the discrimination of trustworthiness is conducted by a value of Dilution of Precision (DOP) outputted by the GPS receiving module.

19. The method as defined in claim 17, wherein the step of determining the current position of the mobile object by way of the terrestrial magnetic field detected by the terrestrial magnetic field sensor module and the acceleration speed detected by the acceleration speed sensor further comprises the steps of: discriminating the azimuth of the mobile object by the terrestrial magnetic field detected by the terrestrial magnetic field sensor module; integrating the acceleration speed detected by the acceleration speed sensor and accumulating integrated signals and discriminating the travel speed of the mobile object; and discriminating the current position of the mobile object by accumulating the azimuth and the travel speed discriminated from a final position where the position detected by the GPS receiving module via the navigation messages was regarded as trustworthy to thereby discriminate the current position of the mobile object.

20. The method as defined in claim 19, wherein the travel speed discrimination is conducted by temperature-compensating and integrating the acceleration speed detected by the acceleration speed sensor in response to the current temperature detected by the temperature sensor, and accumulating the integrated signals.

21. The method as defined in claim 20, wherein the temperature compensation comprises the steps of: calculating a temperature difference between the current temperature detected by the temperature sensor and the predetermined temperature; discriminating a temperature inclination of the acceleration speed sensor relative to the current temperature detected by the temperature sensor; and temperature-compensating the acceleration speed in response to the temperature difference and the temperature inclination.

22. The method as defined in claim 21, wherein the temperature-compensation of the acceleration speed in response to the temperature difference and the temperature inclination is conducted by Expression 1 which is “A=A1+(temperature difference×temperature coefficient)” if the temperature inclination is a positive value and is implemented by Expression 2 which is “A=A1−(temperature difference×temperature coefficient)” if the temperature inclination is a negative value, where A denotes a temperature-compensated acceleration speed, and A1 denotes an acceleration speed detected by the acceleration speed sensor.

23. The method as defined in claim 17, further comprising the step of turning, enlarging and scale-downing a map displayed on a display unit in response to a command inputted from a command input unit.

24. A controlling method of a navigation system, the method comprising the steps of: reading out a map data from a map storage to search a travel route of a mobile object from a starting point to a destination of the mobile object; discriminating whether there is a trustworthiness in a current position of the mobile object detected by a GPS receiving module via navigation messages if the mobile object travels following the search of the travel route; determining as a current position of the mobile object the position detected by the GPS receiving module receiving the navigation messages if there is a trustworthiness as a result of the discrimination; determining a current position of the mobile object by using the terrestrial magnetic field detected by the terrestrial magnetic field sensor module and the acceleration speed of the mobile object detected by the acceleration speed sensor if there is no trustworthiness as a result of the discrimination; and matching the current position of the mobile object thus determined to the map data, displaying the matched current position of the mobile object on a display unit and guiding the searched travel route.

25. The method as defined in claim 24, wherein the discrimination of trustworthiness is conducted by a value of Dilution of Precision (DOP) outputted by the GPS receiving module.

26. The method as defined in claim 24, wherein the step of determining the current position of the mobile object by way of the terrestrial magnetic field detected by the terrestrial magnetic field sensor module and the acceleration speed detected by the acceleration speed sensor further comprises the steps of: discriminating the azimuth of the mobile object by the terrestrial magnetic field detected by the terrestrial magnetic field sensor module; integrating the acceleration speed detected by the acceleration speed sensor and accumulating integrated signals and discriminating the travel speed of the mobile object; and discriminating the current position of the mobile object by accumulating the azimuth and the travel speed discriminated from a final position where the position detected by the GPS receiving module via the navigation messages was regarded as trustworthy to thereby discriminate the current position of the mobile object.

27. The method as defined in claim 26, wherein the travel speed discrimination is conducted by temperature-compensating and integrating the acceleration speed detected by the acceleration speed sensor in response to the current temperature detected by the temperature sensor, and accumulating the integrated signals.

28. The method as defined in claim 27, wherein the temperature compensation comprises the steps of: calculating a temperature difference between the current temperature detected by the temperature sensor and the predetermined temperature; discriminating a temperature inclination of the acceleration speed sensor relative to the current temperature detected by the temperature sensor; and temperature-compensating the acceleration speed in response to the temperature difference and the temperature inclination.

29. The method as defined in claim 28, wherein the temperature-compensation of the acceleration speed in response to the temperature difference and the temperature inclination is conducted by Expression 1 which is “A=A1+(temperature difference×temperature coefficient)” if the temperature inclination is a positive value and is implemented by Expression 2 which is “A=A1−(temperature difference×temperature coefficient)” if the temperature inclination is a negative value, where A denotes a temperature-compensated acceleration speed, and A1 denotes an acceleration speed detected by the acceleration speed sensor.

30. The method as defined in claim 24, further comprising the step of turning, enlarging and scale-downing a map displayed on a display unit in response to a command inputted from a command input unit.
